(19) United States
(12) Patent Application Publication
(10) Pub. No.: US 2024/0187109 A1
(43) Pub. Date: Jun. 6, 2024

(54) AN OPTICAL DETECTOR

(71) Applicant: SIGNIFY HOLDING B.V., EINDHOVEN (NL)

(72) Inventors: CHRISTOPH GERARD AUGUST HOELEN, VALKENSWAARD (NL); LUDOVICUS JOHANNES LAMBERTUS HAENEN, SINT OEDENRODE (NL)

(21) Appl. No.: 18/284,944

(22) PCT Filed: Apr. 5, 2022
(86) PCT No.: PCT/EP2022/058920

§ 371 Date: Sep. 29, 2023

(30) Foreign Application Priority Data
Apr. 8, 2021 (EP) 21167318.1

(51) Int. Cl. H04B 10/69; G02B 3/08; G02B 13/14; H04B 10/116

(52) U.S. Cl. CPC H04B 10/691; G02B 3/08; G02B 13/14; H04B 10/116

(57) ABSTRACT

This invention relates to an optical detector (100) that has enhanced sensitivity for detecting optical signals originating from larger incidence angles. The optical detector (100) may also be used for determining optical signals originating direction. The optical detector (100) comprises a photodetector (101) and a lens (103). The photodetector (101) has a center axis (102) that is lying in a center plane (001) perpendicular to a photodetector plane (002). The lens has a first lens segment (131) and a second lens segment (132) separated by the centerplane (001). The first lens segment (131) comprises a first light receiving surface (133) and a first light exit surface (135), and the first light exit surface (135) is facing the photodetector (101). The second lens segment (132) comprises a second light receiving surface (134) and a second light exit surface (136), and the second light exit surface (134) is facing the photodetector (101). The first light receiving surface (133) comprises a first convex surface with non-constant curvature, the first convex surface having a first minimum radius of curvature (051) at a first surface point. The second light receiving surface (134) comprises a second convex surface with non-constant curvature, the second convex surface having a second minimum radius of curvature (052) at a second surface point. The first angle (053) enclosed by the center axis (102) and a first line (055) is greater than zero degrees, where the first line (055) is normal to the first convex surface at the first surface point and extending up to the center axis (102). And a second angle (054) enclosed by the center axis (102) and a second line (056) is greater than zero degrees, where the second line (056) is normal to the second convex surface at the second surface point and extending up to the center axis (102).

### FIELD OF THE INVENTION

The invention concerns an optical detector that is configured to better receive optical signals originating from wide viewing angles. In addition, the optical detector is configured to robustly determine the direction of incoming optical signals from a plurality of directions. The optical detector may be suitable but not limited to optical wireless communication.

### BACKGROUND OF THE INVENTION

In recent years, optical wireless communication has seen rapid growth in terms of research and commercial activities. High speed, high bandwidth, immunity to electromagnetic interference, and security are attractive features that are driving these activities. Briefly, this is an area of communication in which modulated visible, infrared, or ultraviolet modulated light is used to transmit communication signals in the form of optical signals. This component is configured to transmit optical signals in a wide beam and this is often referred to as the access point, that is connected to the information network. In a generic scenario, multiple access points are set up on the ceiling to cover the area of interest as much as possible. Each of the access points comprising emitters may be incorporated in a ceiling luminaire. At the receiving side, there is an optical device comprising at least a photodetector that is arranged to receive these transmitted optical signals and establish at least one communication link with one of these access points. The receiving side may also comprise an emitter configured to emit a wide beam of the optical signal that in turn is received by one or more photodetectors in the access point in the ceiling. The receiving side is often referred to as the endpoint. Both the access point and the endpoint are essentially optical wireless communication devices that at least accommodate components such as emitter, photodetector, and necessary communication circuitry.

### SUMMARY OF THE INVENTION

An endpoint of the optical wireless communication system may detect an optical signal using a photodetector in combination with an imaging optic. Generally, the amount of light reaching the detector decreases with the cosine of the incident angle (as the projected area becomes smaller) for a detector surface. In addition, for optical wireless communication cases where the receiver translates in a plane parallel to the plane in which the emitter is located, the distance increases (again with the cosine of the angle) for larger incidence angles. In addition, the emitter may emit lower intensity at larger angles with respect to its emission axis (e.g. for a Lambertian emitter again with the cosine of the angle). That means a cosine powered by three dependence, which leads to a strong reduction of detection signal with increasing incidence angle. The detected signal as in detected power for larger incidence angles (i.e. larger translation of the endpoint relative to the position of the access point) becomes very small, reducing the communication link speed dramatically or even cause loss of the link. In turn, the emitter may transmit optical signals with high intensity and the required power dissipations are too high to enable integration into small building blocks (e.g. a mobile phone) as requested for consumer applications.

The photodetector may comprise a plurality of detector segments for determining the directions of incoming optical signals. Using an imaging optic with a plurality of photodetector segments does not provide accurate directional information because the emitters in the access points are very small, which results in almost identical detector signals for many different directions of the incoming optical signals. One may only be able to tell in which photodetector segment the optical signal is received, but not accurately from where the optical signals are originating. For the above-mentioned reasons, it also becomes difficult to realize sufficient angular discrimination if the optical signal is originating from a wide viewing angle.

Therefore it is desirable to increase the gain of the optical element at larger incidence angles or viewing angles to essentially enhanced the sensitivity of the photodetector.

It is an object of the present invention to provide an optical detector having an enhanced sensitivity for larger incidence angles. Therefore, the optical detector is able to better detect optical signals incident from larger incidence angles. Also, the optical detector is configured to robustly determine the approximate directions of the incoming optical signals. In addition, the optical detector may be a part of an optical wireless communication device for detecting optical signals and determining the direction of the access points or endpoints relative to the optical detector and to further assist in transmitting a narrow beam optical signal in a specific direction.

According to a first aspect, this and other objects are achieved by an optical detector for receiving incoming optical signals from a plurality of directions. The optical detector comprises a photodetector and a lens. The photodetector has a center axis that is lying in a center plane perpendicular to a photodetector plane. The lens has a first lens segment and a second lens segment separated by the center plane. The first lens segment comprises a first light receiving surface and a first light exit surface, and the first light exit surface is facing the photodetector. The second lens segment comprises a second light receiving surface and a second light exit surface, and the second light exit surface is facing the photodetector. The first light receiving surface comprises a first convex surface with non-constant curvature, the first convex surface having a first minimum radius of curvature at a first surface point. The second light receiving surface comprises a second convex surface with non-constant curvature, the second convex surface having a second minimum radius of curvature at a second surface point. The first angle enclosed by the center axis and a first line is greater than zero degrees, where the first line is normal to the first convex surface at the first surface point and extending up to the center axis. And a second angle enclosed by the center axis and a second line is greater than zero degrees, where the second line is normal to the second convex surface at the second surface point and extending up to the center axis.

The convex surface allows the concentration of impinging optical signals as long as the transmission medium has a higher refractive index. Therefore, by orienting the convex surface towards an oblique direction with respect to the normal direction, where the normal direction is coincident with the center axis of the lens, one may enhance the concentration of light from certain oblique directions.

The convex surface may have one or more radius of curvatures. For such a curve, the radius of curvature at a certain point equals the radius of a circular arc which best approximates the curve at that point. A minimum radius of curvature can be a global or local minimum radius of curvature indicates. The first angle or the second angle indicating the orientation of this highest curvature point of the convex surface. Any optical signal impinging around the first surface point or the second surface point of the convex surfaces with the impinging direction coinciding with the first line or the second line will experience greater concentration when compared to other parts of the convex surface having lower curvature. Therefore, the optical detector may offer enhanced sensitivity for optical signals that have directions somewhat aligning with the first line or the second line.

The lens may have a lens field of view. The first and the second lens segments may have segmented fields of view. The segmented fields of view may be a subset of the lens field of view. The segmented fields of view may be substantially different, but they may have an overlapping field of view region around the center axis. One way to change the extent of the overlap between the fields of view may be by modifying the light receiving surfaces of the lens segments.

The first angle and the second angle may have the same value in a range between 5 to 45 degrees.

The first lens segment and the second lens segment may be mirror symmetric and also rotational symmetric with respect to the center axis.

The possible choice of the convex surface and its orientation can be quite broad. The choice may depend on the total field-of-view (FoV) required by the application, and how low the concentration of light would be acceptable for other incidence angles, as an increase for certain angles of incidence does imply a reduction at other angles of incidence.

For optical wireless communication, it may be preferred to have the first angle and the second angle somewhere between 5 to 45 degrees.

The first light receiving surface and the second light receiving surface have parts adjacent to the center plane that may be substantially flat or concave.

An optical signal originating from a direction that is coincident with the center axis may likely mean that the optical signal is origination from the shortest distance. Therefore, the intensity of the optical signal is much stronger compared to the optical signal originating from other positions. Therefore, a sacrifice may be made to reduce gain or light concentration for the optical signal originating from a direction that is coincident with the center axis by choosing a concave or flat surface.

The first light receiving surface and the second light receiving surface have parts adjacent to the center plane that curve towards the photodetector plane.

The first light receiving surface and the second light receiving surface have parts adjacent to the center plane that may be configured such that the tangents to the parts of the first light receiving surface and the second light receiving surface can be extended to intersect the center plane and the photodetector plane.

This configuration may result in a stronger reduction in gain or light concentration for the optical signal originating from a direction that is coincident with the center axis. Therefore, this configuration may be chosen if such a condition is not trivial. However, such a stronger reduction for on-axis (the center axis) detection may allow a stronger increase in gain or concentration for off-axis (away from the center axis) detection.

The lens may have a lens edge surface around the edge of the photodetector. The lend edge surface may have a partial covering. The lens edge surface can be perpendicular to the photodetector plane. The partial covering has an outer portion that can be absorptive or reflective and an inner portion that can be reflective. The reflective nature of the inner portion allows folding of the incoming light from high incidence angles that can not be focused on the photodetector plane by the lens. The partial covering may be achieved by a reflective coating or a metal sheet configured on the lens edge surface.

Alternatively, the lens edge surface may not have any form of covering.

Also, the lens edge surface may not be perpendicular to the photodetector plane.

The photodetector may comprise a first photodetector segment and a second photodetector segment configured around the center axis.

The lens described above in combination with a segmented photodetector may allow direction detection capability for the optical detector.

The photodetector can be PN or PiN photodiodes (PDs), avalanche photodiodes (APDs), phototransistors, silicon photomultipliers (SiPMs) or Multi-Pixel Photon Counters (MPPCs), single photon avalanche detectors (SPADs), etc., where not only the SiPM's/MPPCs and SPADs but also the other detectors may comprise multiple segments. The photodetector segments may be arranged concentrically or hexagonally packed. The photodetector segments may also be linearly arranged.

The first light exit surface may be in optical contact with the first photodetector segment, and the second light exit surface may be in optical contact with the second photodetector segment.

In this case, ‘in optical contact’ may be interpreted as enabling optical transmission between the two parts that are in optical contact.

Air may be considered as a coupling medium when the lens and the photodetector are separated by air. However, more Fresnel reflection at the interface of the lens facing the photodetector may lead to more losses of light. So, a medium with a refractive index higher than air is preferred. Otherwise, the photodetector and the lens may have anti-reflection coatings to prevent or at least minimize the loss of light.

The optical contact can be a thin optical bonding layer, or adhesion by means of weak Van der Waals interaction, or a direct interconnect realized by e.g. molding or casting. If the photodetector makes contact with the lens by means of a coupling material, it may be beneficial to have a coupling material with a refractive index between that of the photodetector and the lens and preferably the refractive index of the lens and/or the coupling material are chosen relative close to that of the photodetector.

The first and the second lens segments may be at least partially optically isolated from each other by means of an optical isolator around the center axis.

The ‘at least partially optically isolated’ may be interpreted as the first and the second lens segments being two separate segments and any light impinging of the separation between the segments may result in complete reflection or partial transmission. This extent between complete reflection and partial transmission may be subjective to the angle of incidence.

The optical isolator may be an air gap between the first and second lens segments.

The air gap may be symmetrically arranged around the center plane. At relatively high incidence angles, the incoming optical signals may not be completely concentrated onto the associated photodetector segment and may therefore reach the air gap. The air gap may be designed such that it allows at least partial transmission of the optical signals on the neighboring photodetector segment, promoting cross-talk. In addition the air gap may be designed to reflect substantial optical signal onto the photodetector segment(s) associated with the light receiving lens segment, thereby enhancing the signal strength per unit sensor area used for this detection. Although this cross-talk behavior is not extremely desired for communication, the cross-talk behavior can be utilized for a robust determination of the originating direction of the incoming optical signal. Also, the determination of the originating direction of the incoming optical signal may be possible, albeit with a lesser degree of accuracy, if the lens segments are completely optically isolated from each other by means of reflective materials.

If the optical detector is desired to be used as detecting and demodulating optical signals, then the optical isolator or the air gap may be designed to have limited light transmissivity leading to limited cross-talk. For example, depending on the incidence angle, the light transmission through the optical isolator or the air gap may not exceed 10% of the light impinging on the optical isolator or the air gap. More preferably, 5% of the light impinging on the optical isolator or the air gap may be allowed to be transmitted.

The air gap has a width that may be in a range from 10 to 100 micrometers.

The first lens segment and the second lens segment may have substantially edge surfaces positioned around the center axis and facing each other and wherein the edge surfaces comprise an at least partially transmissive material.

The air gap and the at least partially transmissive material together may represent the optical isolator. The at least partially transmissive material in the form of coating or film may be one of or a combination of dielectric films (e.g. SiO₂, SiNx, TiO₂, and Al₂O₃) or thin metal films with reflective properties, but preferably not having scattering property.

The first and the second lens segment may be manufactured separately with the neighboring edge surfaces covered with at least partially transmissive material and assembled to have the above-mentioned configuration of the lens.

The optical isolator may be a partially transmissive material located between the first and the second lens segments.

The at least partially transmissive material may be chosen so that it is either completely reflective or partially transmissive.

The lens may have a number of lens segments, and the photodetector may have a number of photodetector segments that is the same or an integer multiple of the number of lens segments.

A higher number of photodetector segments per lens segment may be beneficial for the accurate determination of the direction of incoming optical signals.

According to the second aspect of the invention, an optical wireless communication device is provided. The optical wireless communication device comprises the above-mentioned optical detector and a signal processor. The signal processor is configured to receive a plurality of detector signals generated by the first photodetector segment and the second photodetector segment. The optical wireless communication device further comprises a demodulation device. The signal processor is configured to select at least one of the plurality of detector signals and the demodulation device is configured to demodulate at least one of the plurality of detector signals for extracting data.

The signal processor may be a microprocessor or a microcontroller or one or more comparators.

The detector signal can be the quantified power or amplitude of the detected signal measured by the photodetector segment.

For communication purposes, high-frequency modulation is used. Modulation, in general, maybe a form of amplitude modulation, such as on-off keying (OOK), non-return-to-zero on-off keying (NRZ-OOK), or a form of X-level pulse amplitude modulation (PAM-X) such as PAM-3 of PAM-4. Alternatively, a form of frequency modulation may be used, as well as further combinations of modulation techniques, such as optical orthogonal frequency division multiplexing (OOFDM). All modulation techniques used here have in common that they typically modulate an optical beam at relatively high frequencies, e.g. above 1 MHz, to transmit the actual data. Therefore, a high pass filter may be used for filtering the detector signals before being received by the signal processor. The high-pass filter may pass signals above 1 MHz. Extracting data or information from the detector signals, demodulation is needed.

The signal processor may determine from the detector signals which signal may be used to demodulate and extract data or information. The signal processor therefore may select either one or both detector signals for demodulation by the demodulation device. The optical wireless communication device may support multiple input single output (MISO) system.

The optical wireless communication device further comprises an optical signal emitter and a controller. The optical signal emitter may be configured to emit a transmission optical signal in an emission direction that is tunable, and a controller may be configured to control the optical signal emitter. The signal processor may be configured to determine a direction of an incoming optical signal by a comparison of the plurality of detector signals, and the signal processor may be communicatively connected to the controller for tuning the emission direction of the optical signal emitter based on the direction of the incoming optical signal.

The optical detector may have used in the optical wireless communication device with dual roles: 1) detecting optical signals with enhanced off-axis gain and 2) determine the direction of incoming optical signals.

Alternatively, the optical wireless communication device may comprise, an optical signal emitter that may be configured to emit a transmission optical signal in an emission direction that is tunable, a controller configured to control the optical signal emitter, and a direction sensor comprising an optical element and a segmented detector. The signal processor may be configured to determine a direction of an incoming optical signal by comparing the plurality of sensor signals generated by the segmented photodetector. And the signal processor may be communicatively connected to the controller for tuning the emission direction of the optical signal emitter based on the direction of the incoming optical signal.

In this case, the optical detector has a single role to detect optical signals with enhanced off-axis gain. While the direction of the incoming optical signal is determined with a direction sensor. The direction sensor may be a cheap optical sensor comprising an optical element and a segmented photodetector. The optical element can be an imaging or non-imaging type.

To determine the direction of the incident beam or light, a low-pass filter may be used to filter the detector signals. If the optical wireless communication signal is modulated up to e.g. 100 MHz, the directional detection may take place with a signal that is low-pass filtered at 1 MHz or even at 100 kHz. Near direct current (DC) signal may also need to be filtered out, so for the direction detection one may alternatively use a band pass filter between 1 kHz to 100 kHz.

The detector signals filtered by the low-pass filtered signal may be received by the signal processor and the signal processor may be configured to determine the fractions of the detector signals. An example of the fraction can be the magnitude of the detector signal detected by a photodetector segment divided by the total magnitude of the detector signals from all the photodetector segments. By comparing the fractions of the detector signals, the directions of the incoming optical signals can be determined.

The maximum fraction of the low-frequency response of the detector signals may be used to determine from which photodetector segment the communication signal is to be extracted, and thus only a single trans-impedance amplifier (TIA) for the communication signal amplification may be used.

Alternatively, the optical communication signals passing from the different photodetector segments through the high pass filter can be used to determine the direction of the incident beam as well, but this would require multiple trans-impedance amplifiers with high-frequency amplification characteristics.

For determining the relative orientation of the access point(s) or endpoint(s) only, the bandwidth of the photodetector can be 10% or lower than the bandwidth of the incoming optical signals for enabling much more sensitivity. Preferably the 3 dB frequency bandwidth of the photodetector in the direction sensor can be less than 10% of that of the photodetector in the signal sensor used for detecting incoming optical signals with the high modulation frequency. It may be even less, such as <1% or even <0.1%.

Suitable examples of the optical signal emitter can be LEDs, superluminescent light-emitting diodes (SLEDs), edge-emitting laser diodes (ELDs), and vertical-cavity surface-emitting lasers (VCSELs), either as single emitter or a plurality of emitters (or emitting segments).

The optical signal emitter may be configured to emit an optical signal in an emission direction that is tunable within an emitter field of view. The beam of the transmission optical signal may be preferred to have a narrow beam. The use of directional and narrow emission of radiation to the location of the targeted receiver may enable much-increased intensity within the beam shape. Therefore, a reduction in energy dissipation can be expected with an increase in data speed. In addition, a smaller volume can be used thanks to lower thermal dissipation, and eye safety may be improved thanks to a smaller total optical power that needs to be emitted.

The optical signal emitter may be configured to emit with a solid angle that is subtended of less than 60%, preferably less than 30%, most preferably less than 15% of the lens field of view.

The controller may be configured to control the optical signal emitter. The control of the optical signal emitter may include tuning of the emission direction and control of basic emitter properties, for example, intensity, modulation frequency, and wavelength tuning.

The controller may also be responsible for receiving a downlink or uplink signal from the network or the endpoint device, respectively, and convert it to be compatible with optical wireless communication.

It should be understood that the optical detector in all configurations discussed here above may be suitable for use in an endpoint or access point device from the optical wireless communication system. And the purpose of the optical detector may be only to detect optical signals and/or determine source or access point location.

Once the direction of the access point is determined by the signal processor from the incoming optical signals, the signal processor may communicate with the controller for tuning the emission direction to establish communication with the access point or the endpoint.

The optical signal emitter may be configured to emit a plurality of transmission optical signals in a plurality of emission directions that are independently tunable.

With this configuration, the optical wireless communication device may operate in a multiple input multiple output (MIMO) system.

The optical wireless communication device may be part of a mobile endpoint device. In that case, data transfer from the optical wireless communication device (e.g. dongle or mobile phone) may be accomplished through a digital communication interface device. The optical wireless communication device may be communicatively connected to the digital communication interface device by means of a wire, or copper or gold interconnect. The digital communication interface device can be a Universal Serial Bus (USB) interface, a Bluetooth interface, or an Ethernet interface. The mobile optical communication device may be communicatively connected to a user device via the digital communication interface device.

It is noted that the invention relates to all possible combinations of features recited in the claims. Other objectives, features, and advantages of the present inventive concept will appear from the following detailed disclosure, from the attached claims as well as from the drawings. A feature described in relation to one of the aspects may also be incorporated in the other aspect, and the advantage of the feature is applicable to all aspects in which it is incorporated.

### BRIEF DESCRIPTION OF THE DRAWINGS

The above, as well as additional objects, features, and advantages of the disclosed devices, methods, and systems, will be better understood through the following illustrative and non-limiting detailed description of embodiments of devices, methods, and systems, with reference to the appended drawings, in which:

FIG. 1 shows a cross-sectional view of an optical detector;

FIG. 2 shows the operation of an optical detector in a cross-sectional view;

FIG. 3 shows a cross-sectional view of an alternative configuration of an optical detector;

FIGS. 4(a) and (b) show cross-sections of optical detectors with alternatives for the optical isolator;

FIG. 5 shows a cross-sectional view of yet another alternative configuration of an optical detector;

FIGS. 6(a), (b), and (c) show cross-sections of optical detectors with various configurations of the light receiving surfaces of the lens segments;

FIG. 7 schematically shows an optical wireless communication device comprising the optical detector for detecting incoming optical signals; and

FIGS. 8(a) and (b) schematically show an optical wireless communication device comprising the optical detector for determining the direction and a controller for controlling a single-beam and a multi-beam emitter, respectively; and

FIG. 9 schematically shows an optical wireless communication device comprising the optical detector for detecting incoming optical signals and a direction sensor for determining direction.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

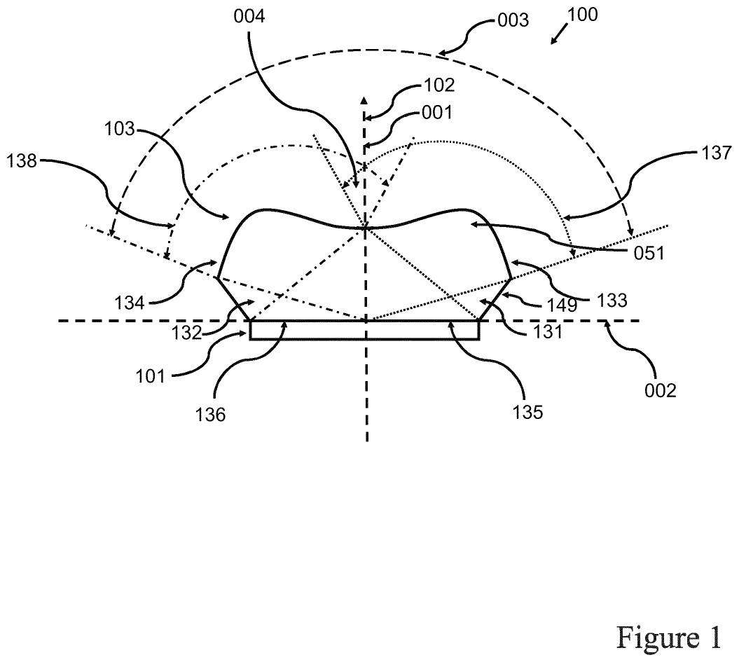

Referring initially to FIG. 1, a cross-sectional view of an optical detector 100 is shown. The optical detector 100 comprises a photodetector 101. The photodetector 101 has a center axis 102 that is lying in a center plane 001 perpendicular to a photodetector plane 002. The optical detector 100 further comprises a lens 103 having a first and a second lens segments 131 and 132, respectively. The lens segments 131 and 132 are separated by the center axis 102. The lens segments 131 and 132 comprise a first and a second light receiving surfaces 133 and 134, respectively, and similarly, a first and a second light exit surfaces 135 and 136, respectively. The light receiving surfaces 133 and 134 are larger than the light exit surfaces 135 and 136. Besides, the light receiving surfaces 133 and 134 have at least in part a first and a second convex surface, respectively to concentrate the one or more incoming optical signals.

The light exit surfaces 135 and 136 are in optical contact with the photodetector 101.

The lens 103 has a lens field of view 003. The first and the second lens segments 131 and 132, respectively comprise segmented fields of view 137 and 138, respectively. The segmented fields of view 137 and 138 comprise a subset of the lens field of view 003. The segmented fields of view 137 and 138 are substantially different, but they have an overlapping field of view region 004 around the center axis 102. One way to change the extent of the overlap between the fields of view may be by modifying the light receiving surfaces of the lens segments.

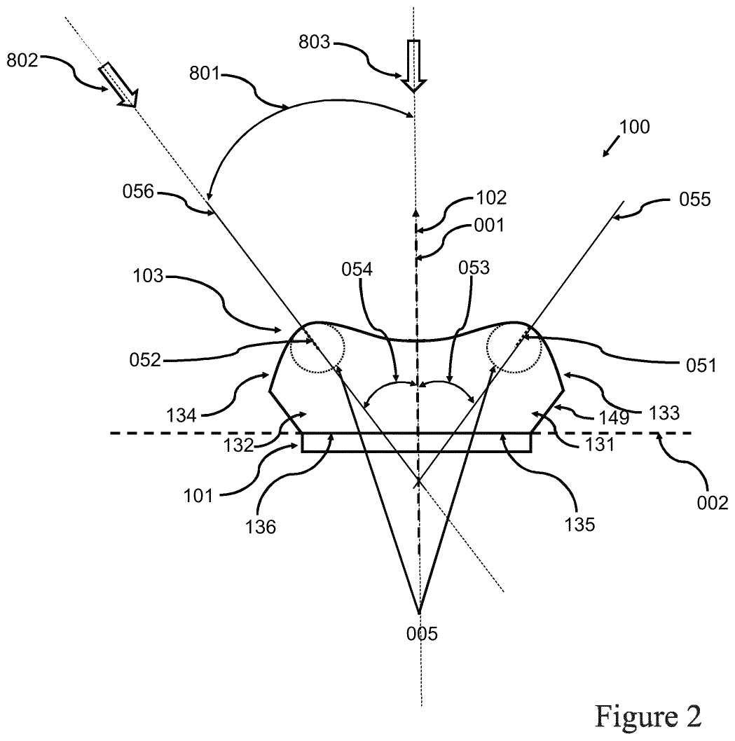

FIG. 2 shows the operation of an optical detector 100 in a cross-sectional view. For certain applications, it may be desired to realize an enhanced light reception capability for incoming optical signals incident from different directions other than normal to the photodetector plane 002. For example, this may be relevant for optical wireless communication where the endpoint devices comprising optical detectors most often may find themselves not directly under the access points. Therefore, it can be beneficial to have an increased gain such as increased light concentration factor of the lens for detecting incoming optical signals originating from larger than zero incidence angles, where the incidence angle 801 is defined by an enclosed angle between the oblique direction 802 of the incoming optical signal and the center axis 102. And for the optical signals that are originating from a normal direction 803 that is normal to the photodetector plane 002 and parallel to the center axis 102, the light concentration factor may be sacrificed since the optical signals may have sufficient intensity owing to the direct field of view and the shortest distance between the access point and endpoint. According to the invention, the light receiving surface 133 and 134 of the lens segments 131 and 132, respectively can be modified to achieve the increased light concentration factor for incidence angles greater than zero degrees, where the incidence angle is defined by an enclosed angle between the direction of the incoming optical signals and the center axis 102.

In FIG. 2, the first light receiving surface 133 of the first lens segment 131 at least in part has a first convex surface. The first convex surface with non-constant curvature having a first minimum radius of curvature 051 at a first surface point. A first line 055 can be extended up to the center axis 102 that is normal to the first convex surface at the first surface point of the first minimum radius of curvature 051. The first line 055 encloses a first angle 053 with the center axis 102 that is greater than zero degrees. Similarly, a second angle 054 enclosed by the center axis 102 and a second line 056 is greater than zero degrees, where the second line 056 is normal to the second convex surface at the second surface point of the second minimum radius of curvature 052 and extending up to the center axis 102. The first and second minimum radius of curvatures 051 and 052, respectively are defined by the imaginary circles 005. In FIG. 2, the first angle 053 and the second angle 054 are the same. Therefore, the first light receiving surface 133 and the second light receiving 134 are mirror images of each other separated by the center axis 102. It can be considered that the lens segments 131 and 132 are symmetrical and they are also rotationally symmetric.

The oblique direction 802 of the incoming optical signal is shown coincident with the second line 056. Therefore, the second convex surface of the second light receiving surface 134 is essentially configured to face the incoming optical signal from an oblique direction 802 where the light incidence angle is greater than zero degrees. As a result, the light concentration property of the lens 103 is at least substantially higher for light originating from an oblique position. Because incoming optical signal originating from a normal direction 803 will experience lesser light concentration as parts of the first light receiving surface 133 and the second light receiving surface 134 adjacent to the center plane 001 are substantially concave. Therefore, the light receiving surfaces 133 and 134 are adapted to provide greater gain for off-axis incoming light (obliquely originated) than on-axis incoming light (normally originated). As a result, the optical detector 100 has the characteristics of enhanced sensitivity for signals originating from larger incidence angles.

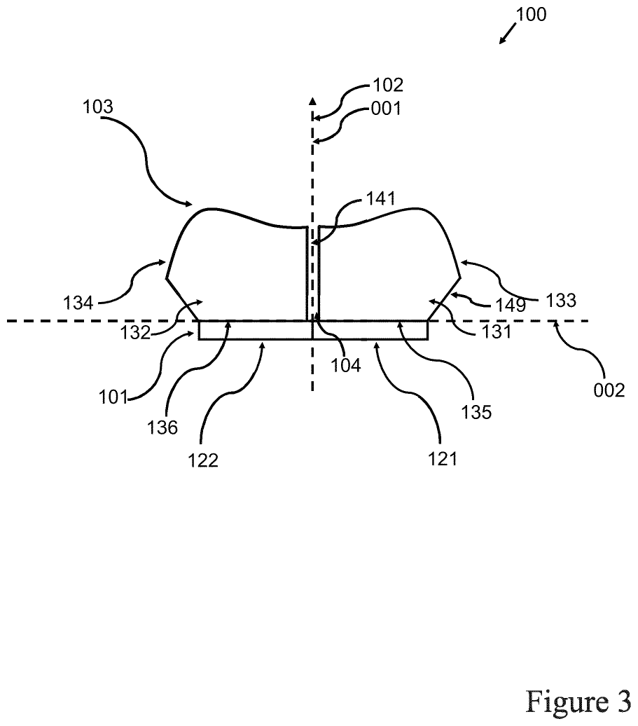

In FIG. 3, a cross-sectional view of an optical detector 100 is shown where The lens segment 131 and 132 are partially optically isolated from each other by means of an optical isolator 104. The optical isolator 104 is an air gap 141 is symmetrically arranged around the center plane 001. The first and the second light receiving surfaces 133 and 134, respectively have the same characteristics as shown in FIGS. 1 and 2. The photodetector 101 has a first photodetector segment 121 and a second photodetector segment 122 configured around the center axis 102. The first lens segment 131 is in optical contact with the first photodetector segment 121 and similarly, the second lens segment 132 is in optical contact with the second photodetector segment 122.

At relatively high incidence angles, the incoming optical signals may not be completely concentrated onto the associated photodetector segment and may therefore reach the air gap 141. The air gap 141 may be designed such that it allows at least partial transmission of the optical signals on the neighboring photodetector segment. And reflect substantial optical signal onto the photodetector segment(s) associated with the light receiving lens segment. Therefore, a careful examination of the light received by the photodetectors and knowing the partial transmissivity for different light incidence angles, a robust determination of the originating direction of the incoming optical signal may be possible. Determination of the originating direction of the incoming optical signal may be possible if the lens segments are completely optically isolated from each other by means of reflective materials. If the optical detector 100 is desired to be used as detecting and demodulating optical signals from an access point, then the optical isolator 104 or the air gap 141 may be designed to have limited light transmissivity. For example, depending on the incidence angle, the light transmission through the optical isolator 104 or the air gap 141 may not exceed 10% of the light impinging on the optical isolator 104 or the air gap 141. More preferably, 5% of the light impinging on the optical isolator 104 or the air gap 141 may be allowed to be transmitted.

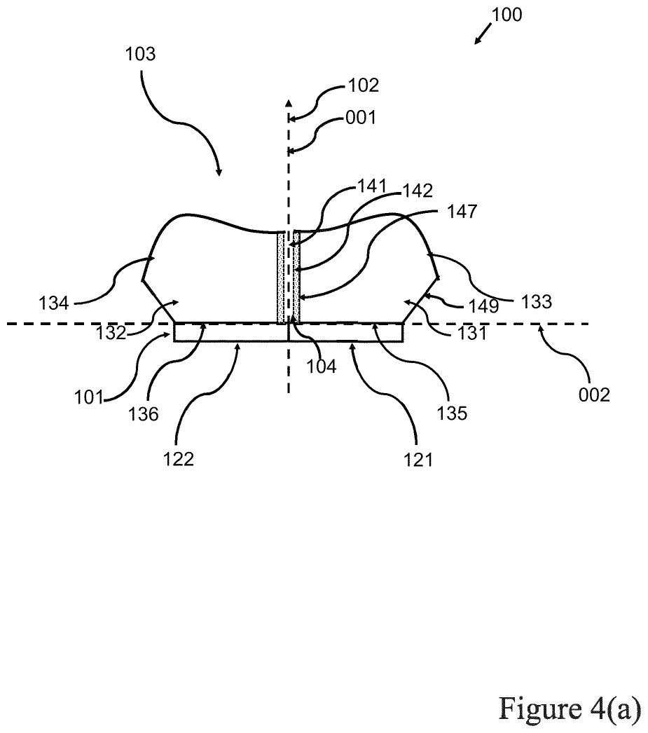

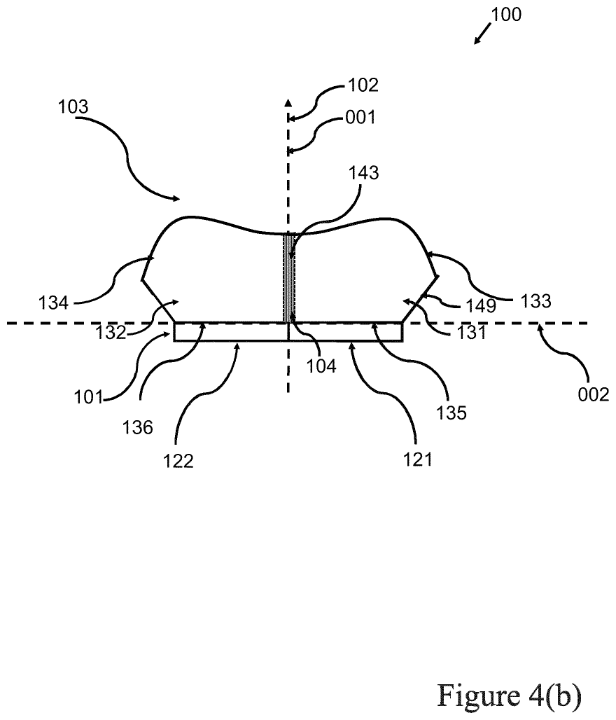

FIGS. 4(a) and (b) show cross-sections of the optical detectors 100 with alternatives for the optical isolator 104. It should be noted that FIG. 4 comprises features, elements, and/or functions as shown in FIGS. 1 to 3 and described in the associated text. Hence, it is also referred to those figures and the description relating thereto for an increased understanding. The same reference numerals in FIGS. 1 to 4 denote the same or similar components, having the same or similar function.

In FIG. 4(a), the lens segments 131 and 132 are separated by an air gap 141. The edge surfaces 147 facing the lens segments 131 and 132 are substantially flat and they comprise at least partially transmissive material 142, perhaps in the form of a coating. The air gap 141 and the at least partially transmissive material 142 together may represent the optical isolator 104. The width of the air gap 141 and the choice of the at least partially transmissive material 142 may allow tuning of the light transmission through the optical isolator 104. The at least partially transmissive material 142 may be one of or a combination of dielectric films (e.g. SiO₂, SiNₓ, TiO₂, and Al₂O₃) or thin metal films with reflective properties.

In FIG. 4(b), the optical isolator 104 is represented by an at least partially transmissive material 143 located between the adjoining lens segments 131 and 132. The at least partially transmissive material 143 may be chosen so that it is either completely reflective or partially transmissive.

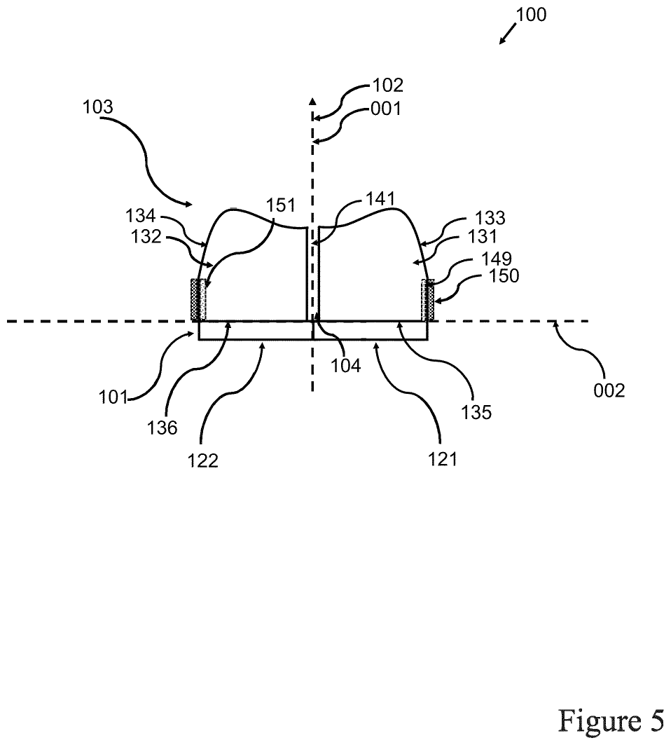

FIG. 5 shows a cross-sectional view of an optical detector 100 similar to FIG. 3. It should be noted that FIG. 5 comprises features, elements, and/or functions as shown in FIGS. 1 to 4 and described in the associated text. Hence, it is also referred to those figures and the description relating thereto for an increased understanding. The same reference numerals in FIGS. 1 to 5 denote the same or similar components, having the same or similar function.

In FIG. 5, the lens 103 has lens edge surfaces 149 around the edges of the photodetector 101. The lens edge surfaces 149 have partial covering. The lens edge surface 149 is shown perpendicular to the photodetector plane 002. The partial covering has an outer portion 150 that can be absorptive or reflective and an inner portion 151 that can be reflective. The reflective nature of the inner portion 151 allows folding of the incoming light from high incidence angles that can not be focused on the photodetector plane 002 by the lens 103. The partial covering may be achieved by a reflective coating or a metal sheet configured on the lens edge surface. Alternative to the optical detector 100, the lens edge surface 149 may not have any form of covering as well. Also, the lens edge surface may not be perpendicular to the photodetector plane 002 as shown in FIGS. 1 to 4.

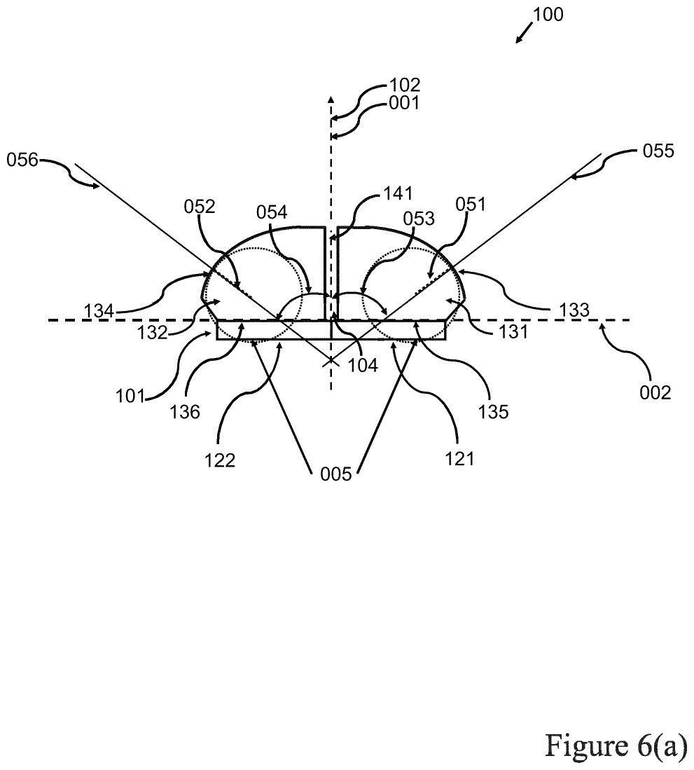

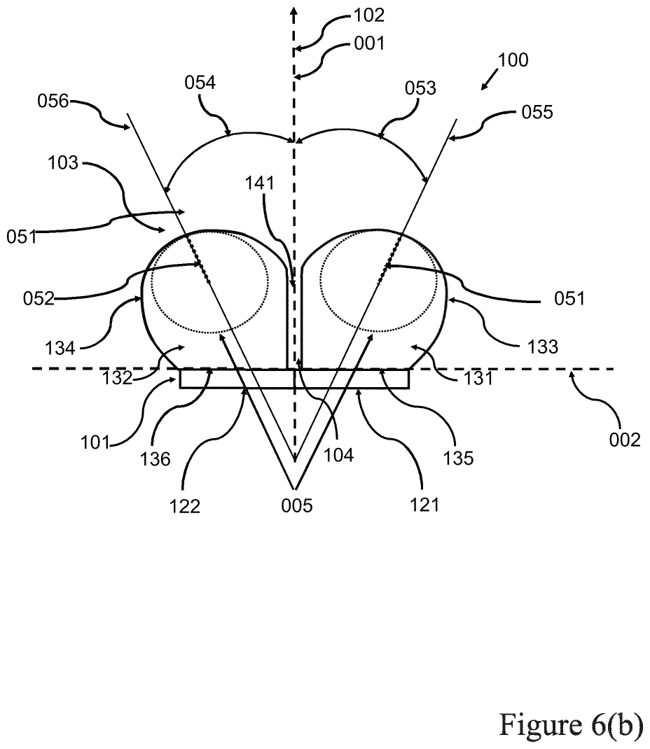

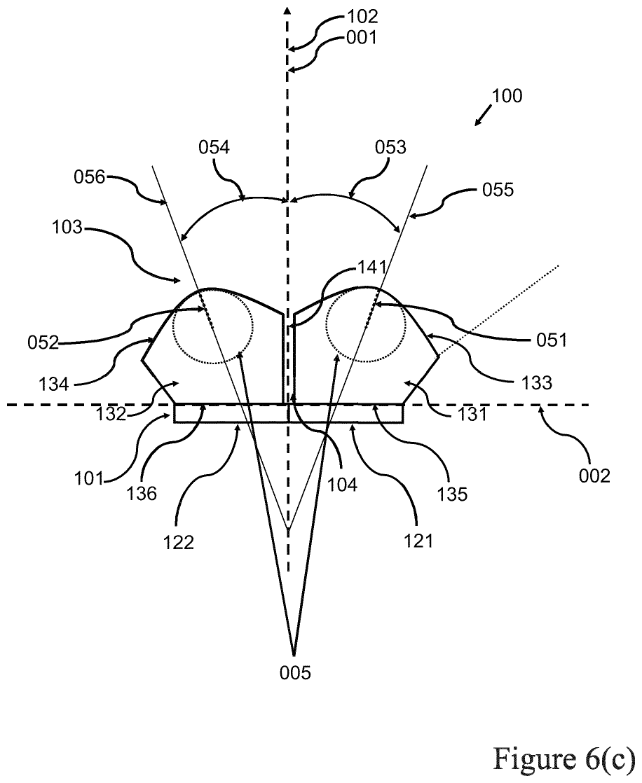

FIGS. 6(a), (b), and (c) show cross-sections of optical detectors 100 with various configurations of the light receiving surfaces 133 and 134 of the lens segments 131 and 132, respectively. It should be noted that FIG. 6 comprises features, elements, and/or functions as shown in FIGS. 1 to 5 and described in the associated text. Hence, it is also referred to those figures and the description relating thereto for an increased understanding. The same reference numerals in FIGS. 1 to 6 denote the same or similar components, having the same or similar function.

In FIG. 6(a), the first light receiving surface 133 and the second light receiving surface 134 adjacent to the center plane 001 are shown to be substantially flat. On other hand, the first light receiving surface 133 has in part a first convex surface that has the first minimum radius of curvature 051 being part of an imaginary circle 005. In this regard, the second light receiving surface 134 is shown to be mirror symmetric. The first angle 053 is enclosed by the center axis 102 and the first line 055 and it is shown to be approximately 40 degrees. In FIGS. 6(b) and (c), the light receiving surfaces 133 and 134 are shown to comprise different configurations of the convex surface with the first angle 053 and second angle 054 are also shown to be the same and approximately around 15 to 20 degrees. The parts of the first light receiving surface 133 and the second light receiving surface 134 adjacent to the center plane 001 are configured curve towards the photodetector plane 002 such that the tangents can be extended to intersect the center plane 001 and the photodetector plane 002. Therefore, incoming light perpendicular to the normal plane will be much weakly concentrated when compared to the configuration shown in FIG. 6(a).

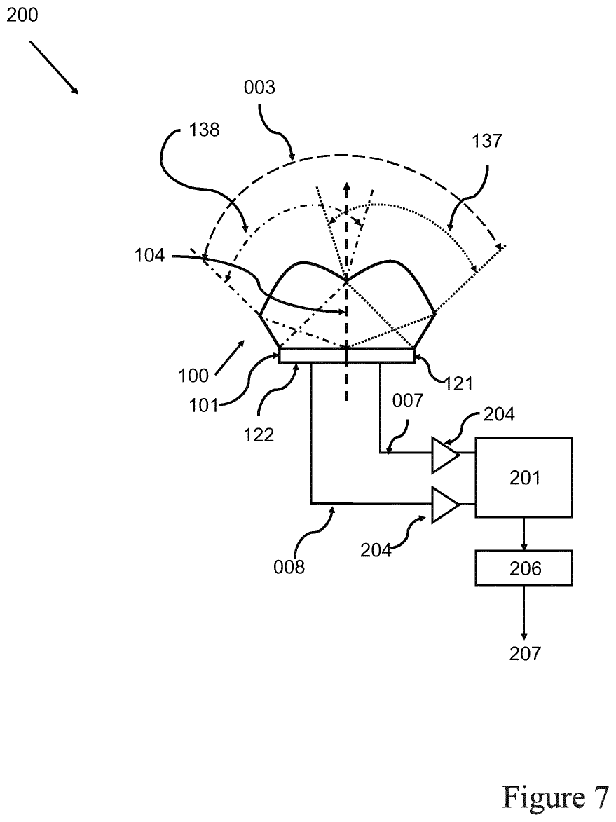

FIG. 7 schematically shows an optical wireless communication device 200 comprising the optical detector 100 with enhanced sensitivity for detecting the incoming optical signals from larger angles. It should be noted that FIG. 7 comprises features, elements and/or functions as shown in FIGS. 1 to 6, and described in the associated text. Hence, it is also referred to that figure and the description relating thereto for an increased understanding. The same reference numerals in FIGS. 1 to 7, denote the same or similar components, having the same or similar function.

The optical wireless communication device 200 further comprises a signal processor 201 that is configured to receive the detector signals 007 and 008 from the photodetector segments 121 and 122, respectively. The signal processor 201 may be a microprocessor or a microcontroller or one or more comparators. Here, the detector signal can be quantified as the power or amplitude of the detected signal measured by the photodetector segment. For communication purposes, high-frequency modulation is used. Therefore, a high pass filter 204 is used for filtering the detector signals 007 and 008 before being received by the signal processor 201. The high-pass filter 204 may pass signals above 1 MHz. Extracting data or information from the detector signals 007 and 008, demodulation is needed. The signal processor 201 may determine from the detector signals 007, 008, which photodetector segment 121, 122 may be used to demodulate and extract data or information. The signal processor 201 therefore may select either one or both detector signals 007, 008 for demodulation by a demodulation device 206. Potentially, the optical wireless communication device 200 comprising the optical detector 100 supports multiple input single output (MISO) and multiple input and multiple output (MIMO) system. The demodulated signal 207 can be the downlink signal received by the optical detector 100. A similar principle applies for photodetector having only one segment, but in this case signal processor 201 may simply pass the detector signal for demodulation. In this case, the detector signals 007 and 008 are the same for a photodetector with a single segment and therefore, the signal processor would not require to compare the detector signal.

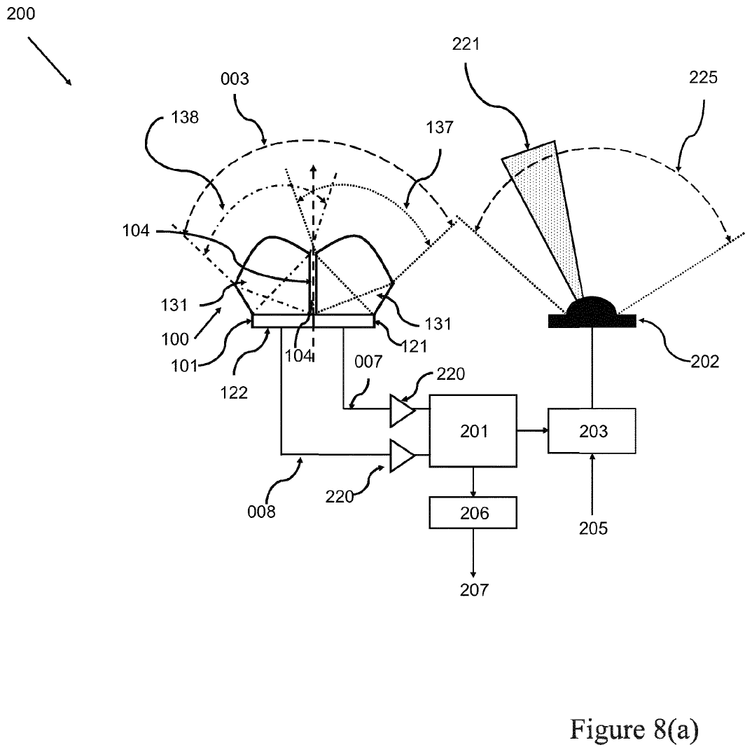

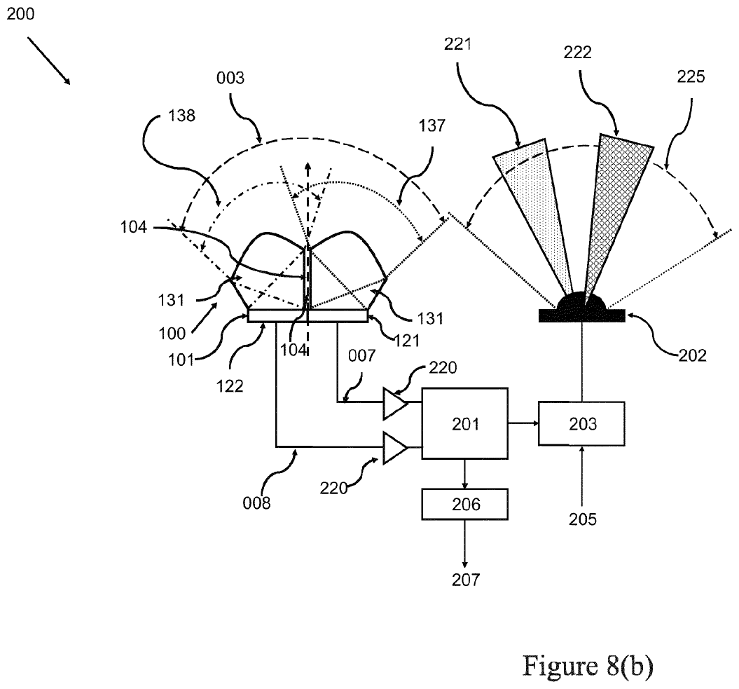

FIG. 8 schematically shows an optical wireless communication device 200 comprising the optical detector 100 for determining the direction of the incoming optical signals. It should be noted that FIG. 8 comprises features, elements, and/or functions as shown in FIGS. 1 to 7, and described in the associated text. Hence, it is also referred to that figure and the description relating thereto for an increased understanding. The same reference numerals in FIGS. 1 to 8, denote the same or similar components, having the same or similar function.

The optical wireless communication device 200 may also comprise a low-pass filter for filtering detector signals 007 and 008 that are used to determine the direction of the incident beam of light. The detector signals 007 and 008 filtered by the low-pass filtered signal are received by the signal processor 201 that is configured to compare the detector signals 007 and 008. The basis of this comparison can be fractions of the detector signals 007 and 008. An example of the fraction can be the magnitude of the signal detected by a photodetector segment divided by the total magnitude of the detector signals from all the photodetector segments. By comparing the fractions of the detector signals 007 and 008, the directions of the incoming optical signals can be determined. A optical isolator 104 similar to an air gap between the lens segments 131 and 132 can facilitate optical cross-talk. The signal processor 201 may also take into account the transmissivity through the optical isolator 104 for various incidence angles for robust direct detection. The maximum fraction of the low-frequency response of the detector signals may be used to determine from which photodetector segment the communication signal is to be extracted, and thus only a single trans-impedance amplifier (TIA) for the communication signal amplification may be used.

Alternatively, the optical communication signals passing from the different photodetector segments through the high pass filter can be used to determine the direction of the incident beam as well, but this would require multiple trans-impedance amplifiers with high-frequency amplification characteristics.

For determining the relative orientation of the access point(s) or endpoint(s), the bandwidth of the photodetector can be 10% or lower than the bandwidth of the incoming optical signals for enabling much more sensitivity. Preferably the 3 dB frequency bandwidth of the photodetector in the direction sensor can be less than 10% of that of the photodetector in the signal sensor used for detecting incoming optical signals with the high modulation frequency. It may be even less, such as <1% or even <0.1%. If the optical wireless communication signal is modulated up to e.g. 100 MHz, the directional detection may take place with a signal that is low-pass filtered at 1 MHz or even at 100 kHz. Near direct current (DC) signal may also need to be filtered out, so for the direction detection, one may alternatively use a bandpass filter between 1 kHz to 100 kHz.

In FIG. 8(a), the optical wireless communication device 200 also comprises an optical signal emitter 202 configured to emit an optical signal 221 in an emission direction that is tunable within an emitter field of view 225. The beam of the transmission optical signal 221 can be narrow. For example, the optical signal emitter 202 may be configured to emit with a solid angle that is subtended of less than 60%, preferably less than 30%, most preferably less than 15% of the lens field of view 003. A controller 203 is present with the optical wireless communication device 200 that is configured to control the optical signal emitter 202. The control of the optical signal emitter 202 may include tuning of the emission direction and control of basic emitter properties, for example, intensity, modulation frequency, and wavelength tuning. The controller 203 may also be responsible for receiving a downlink or uplink signal 205 from the network connected to the access point or the endpoint device, respectively, and convert it to be compatible with optical wireless communication.

The optical detector 100 and the optical communication device 200 described above may be suitably used for determining origins of multiple incoming optical signals. As shown in FIG. 8(b), this feature can be exploited to control an optical signal emitter 202 that is configured to emit two transmission optical signals 221 and 222 so that multiple optical communication links can be established. Hence, it is valuable to be able to control an optical signal emitter 202 having multiple tunable narrow beams for sustaining a high throughput multiple-input multiple-output (MIMO) system with the access points or endpoints. As shown in FIG. 8(b), two transmission optical signals 221 and 222 in emission directions are independently tunable within an emitter field of view 225.

It should be understood that the optical detector 100 in all configurations discussed hereabove may be suitable for use in an endpoint or access point device from the optical wireless communication system. And the purpose of the optical detector 100 maybe to detect optical signals and/or determine source or access point location.

The signal processor 201 is communicatively connected to the controller 203. Once the direction of the access point is determined by signal processor 201 from the incoming optical signals, the signal processor 201 may communicate with the controller 203 for tuning the emission direction to establish communication with the access point or the endpoint. In FIG. 8, the role of the optical detector 100 is to determine the direction of the incoming optical signals for robustly isolating the access point or endpoint position(s) i.e. a direction sensor, and eventually facilitating the control of a narrow beam emitting optical signal emitter.

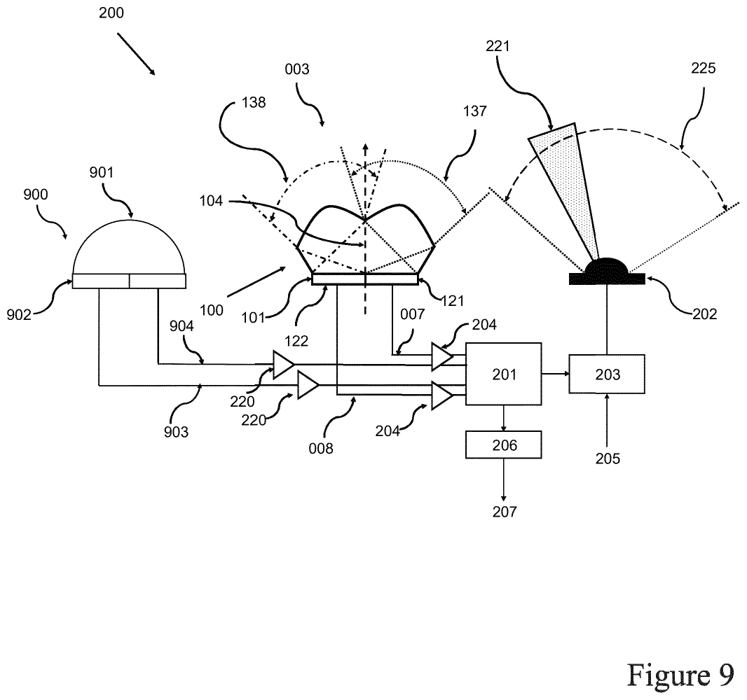

FIG. 9 schematically shows an optical wireless communication device 200 comprising the optical detector 100 for detecting incoming optical signals and a direction sensor 900 for determining directions of the incoming optical signals. It should be noted that FIG. 9 comprises features, elements, and/or functions as shown in FIGS. 1 to 8, and described in the associated text. Hence, it is also referred to that figure and the description relating thereto for an increased understanding. The same reference numerals in FIGS. 1 to 9, denote the same or similar components, having the same or similar function.

In FIG. 9, a direction sensor 900 comprising an optical element 901 and segmented detector 902 that are used for determining the direction of the incoming optical signal. The optical element 901 can be an imaging or a non-imaging optics. One may also consider various known configurations for the direction detector from the art. The sensor signals 903 and 904 are passed through low-pass filters 220 and received by the signal processor 201. The signal processor 201 is configured to determine the direction based on comparison of the sensor signals 903 and 904. Similar to FIG. 7, the optical detector 100 is used for detecting large incidence angle originated optical signals with enhanced sensitivity, which are eventually used for extracting data or information.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements.

The mere fact that certain features are recited in mutually different dependent claims does not indicate that a combination of these features cannot be used to advantage. The various aspects discussed above may be combined in order to provide additional advantages. Further, the person skilled in the art will understand that two or more embodiments may be combined.

1. An optical detector for receiving incoming optical signals from a plurality of directions, wherein the optical detector comprises:
a photodetector having a center axis that is lying in a center plane perpendicular to a photodetector plane,
a lens having a first lens segment and a second lens segment separated by the center plane,
wherein the photodetector comprises a first photodetector segment and a second photodetector segment configured around the center axis;
wherein the first lens segment comprises a first light receiving surface and a first light exit surface, and the first light exit surface is facing the photodetector, wherein the second lens segment comprises a second light receiving surface and a second light exit surface, and the second light exit surface is facing the photodetector,
wherein the first light receiving surface comprises a first convex surface with non-constant curvature, the first convex surface having a first minimum radius of curvature at a first surface point,
wherein the second light receiving surface comprises a second convex surface with non-constant curvature, the second convex surface having a second minimum radius of curvature at a second surface point,
wherein the first lens segment and the second lens segment are at least partially optically isolated from each other by an air gap between the first and second lens segments, and the first lens segment and the second lens segment have substantially flat edge surfaces positioned around the center axis and facing each other, and wherein the edge surfaces comprising an at least partially transmissive material,
wherein a first angle enclosed by the center axis and a first line is greater than zero degrees, the first line being normal to the first convex surface at the first surface point and extending up to the center axis, and
wherein a second angle enclosed by the center axis and a second line is greater than zero degrees, the second line being normal to the second convex surface at the second surface point and extending up to the center axis.

2. The optical detector according to claim 1, wherein the first angle and the second angle have the same value in a range between 5 to 45 degrees.

3. The optical detector according to claim 1, wherein the first light receiving surface and the second light receiving surface have parts adjacent to the center plane that are substantially flat or concave.

4. The optical detector according to claim 1, wherein the first light receiving surface and the second light receiving surface have parts adjacent to the center plane that curve towards the photodetector plane.

5. The optical detector according to claim 1, wherein the first light exit surface is in optical contact with the first photodetector segment, and the second light exit surface is in optical contact with the second photodetector segment.

6. The optical detector according to claim 1, wherein the air gap has a width in a range from 10 to 100 micrometers.

7. The optical detector according to claim 1, wherein the lens has a number of lens segments and wherein the photodetector has a number of photodetector segments that is the same or an integer multiple of the number of lens segments.

8. An optical wireless communication device comprising:
the optical detector according to claim 1,
a signal processor configured to receive a plurality of detector signals generated by the first photodetector segment and the second photodetector segment, respectively, and
a demodulation device,
wherein the signal processor is configured to select at least one of the plurality of detector signals, and
wherein the demodulation device is configured to demodulate at least one of the plurality of detector signals for extracting data.

9. The optical wireless communication device according to claim 8, wherein the optical wireless communication device further comprises,
an optical signal emitter configured to emit a transmission optical signal in an emission direction that is tunable, and
a controller configured to control the optical signal emitter,
wherein the signal processor is configured to determine a direction of an incoming optical signal by a comparison of the plurality of detector signals, and
wherein the signal processor is communicatively connected to the controller for tuning the emission direction of the optical signal emitter based on the direction of the incoming optical signal.

10. The optical wireless communication device according to claim 8, wherein the optical wireless communication device further comprises,
an optical signal emitter configured to emit a transmission optical signal in an emission direction that is tunable,
a controller configured to control the optical signal emitter, and
a direction sensor comprising an optical element and a segmented detector,
wherein the signal processor is configured to determine a direction of an incoming optical signal by comparing of the plurality of sensor signals generated by the segmented photodetector, and
wherein the signal processor is communicatively connected to the controller for tuning the emission direction of the optical signal emitter based on the direction of the incoming optical signal.
